(19) United States
(12) Patent Application Publication
(10) Pub. No.: US 2015/0156233 A1
(43) Pub. Date: Jun. 4, 2015

(54) METHOD AND SYSTEM FOR OPERATING A COLLABORATIVE NETWORK

(71) Applicant: Sift Co., Honolulu, HI (US)

(72) Inventors: Rolv Alexander Bergo, Honolulu, HI (US); Viil Lid, Honolulu, HI (US); Aaron Bronson Rosa, Honolulu, HI (US)

(21) Appl. No.: 14/560,812

(22) Filed: Dec. 4, 2014

Related U.S. Application Data
(60) Provisional application No. 61/911,849, filed on Dec. 4, 2013.

(51) Int. Cl. H04L 29/06; G06F 3/0484

(52) U.S. Cl. CPC H04L 65/403; G06F 3/04842

(57) ABSTRACT

A method and system for operating a collaborative network of participants attending an event/meeting presentation in person employs a web-based control server connected online with participants using their personal networked computer devices. The control server sends a question or prompt to and receives inputs from participants via the display screens of their personal networked computer devices, and calculates aggregated results of participant users' inputs for display on the event/meeting display screen, then sends a next question or prompt to the participants for a next activity step of the group activity. Real-time group interactivity of participants in the event/meeting presentation is enabled through mobility and convenience of participants using their networked personal computer devices such as smartphones for participating in the group activity.

This U.S. patent application claims the priority benefit of U.S. Provisional Application No. 61/911,849, filed on Dec. 4, 2013.

### TECHNICAL FIELD

This invention generally relates to a computerized method and system for operating a collaborative network of personal networked computer devices. More specifically, it is directed to configuration of multiple personal networked computer devices to act as a collaborative network system facilitating data gathering, parsing, and aggregation for collaborative group processes.

### BACKGROUND OF INVENTION

The World Wide Web is developed as a global network of computer networks for communication among universes of networked computer devices. The numbers of networked computer devices and varieties of online services offered for them have increased exponentially. These services have greatly enhanced individual communication capacity, developing with paging, short message services, voice and audio communications, and worldwide Internet browsing. Collaborative services have been developed to allow multiple networked computer devices to work in concert for data gathering within a common activity in order to complete a multi-step process engaged by a networked (collaborative) group of users. However, networked collaborative services have typically limited the breadth and speed of collaboration by restricting the use of data due to security concerns, and often requiring that proprietary hardware and software be used for handling data communications in collaborative processes. Additionally, data visualization is often made difficult because of restrictions on screen size, and incompatibilities across non-uniform systems.

### SUMMARY OF INVENTION

A method of operating a collaborative network of participants attending an event/meeting presentation in person using networked computer devices connected via Internet, comprising:

operating a web-based control server connected online with a plurality of participant users attending the event/meeting presentation in person using personal networked computer devices to receive inputs from and to send information for display to the participant users on display screens of their personal networked computer devices, and to send information for display on an event/meeting display screen for the event/meeting presentation to the plurality of participant users attending the event/meeting in person,

wherein operating the web-based control server includes:

(1) sending a question or prompt to the participant users on display screens of their personal networked computer devices for participant users' inputs to a current activity step of the group activity;

(2) receiving participant users' inputs via their personal networked computer devices to a current activity step of the group activity;

(3) calculating aggregated results of participant users' inputs to the current activity step of the group activity;

(4) sending the aggregated results of participant users' inputs to the current activity step of the group activity for display on the event/meeting display screen to the plurality of participant users; and

(5) sending a question or prompt to the participant users on display screens of their personal networked computer devices for participant users' inputs to a next activity step of the group activity,

whereby real-time group interactivity of participants in the event/meeting presentation for the group activity is enabled through mobility and convenience of participant users using their networked personal computer devices.

The present invention is directed to a system and method for operating a collaborative network of a network control system, an event/meeting presentation having a networked display, and a plurality of participants using networked personal or mobile computer devices. The collaborative network enables real-time synchronization of participants' activities in a collaborative group multi-step process by dynamically updating the displays of users' computer devices in conjunction with the presentation display of the event/meeting. The control system may be a web-based server having a control display for a collaborative network administrator to coordinate and push information updated in real-time to the displays of the users' computer devices and to the event/meeting presentation display for participants at a physical location, such as at a meeting location, conference room, videoconference center, etc. The collaborative control system coordinates the displays on the three (or more) sets of screens (control screen, event/meeting screen, participants screens) to enable real-time interactivity for participants in the collaborative group process.

According to an important aspect of the present invention, participant-generated information input on their personal or mobile computer devices in response to questions or prompts for a current question or activity in the collaborative group process are received and analyzed at the web-based control center. The control center evaluates the participant input information and calculates an aggregate result as real-time feedback for the event/meeting. Upon the administrator actuating a “Next” control button, the control system pushes information to the event/meeting screen to display the aggregate result for the current question or activity, and also pushes information to the participants computer devices to display the next question or activity in the collaboration group process.

In a preferred embodiment, the control system of the collaboration network administrator may be enabled to control participation in an event/meeting via each participant's personal or mobile computer device. The control system may allow and/or restrict participant access to certain steps or whole activities within the collaboration group process by controlling the display interface of each participant's display screen.

Participant data may be stored by the control center in relation to participants, group, and/or group activity from which it was gathered. The stored participant data may be subjected to statistical, textual, and/or other analysis for generating a group data visualization display. The control system can control the event/meeting display screen separately or in unison with participants' display screens. The control center may control individual participant screens as one group, or as multiple groups of respectively selected or self-selected participants.

### BRIEF DESCRIPTION OF THE DRAWINGS

The accompanying drawings, which are incorporated in and constitute a part of the Specification, illustrate various examples of preferred embodiments of the invention. It will be appreciated that elements (e.g., boxes, groups of boxes, or other shapes) depicted in specific figures may show one example how a computerized function encompassed in that element's boundaries may be depicted. One of ordinary skill in the art will appreciate that an element may be depicted as multiple elements or that multiple elements may be depicted as one element. An element shown as an internal component of another element may be implemented as an external component and vice versa. Furthermore, elements may not be drawn to scale.

FIG. 1 is a schematic diagram that shows an exemplary overview of a system for operating a collaborative network in accordance with the present invention.

FIG. 2 illustrates a functional block diagram for operation of a web-based server at a control center for the collaborative network system.

FIG. 3 illustrates a functional block diagram for an overview of communication between the control center and participants' computer devices.

FIG. 4 illustrates a functional block diagram for operation of the collaborative network system for participants in a group collaboration process.

FIG. 5 illustrates a functional block diagram for operation of the collaborative network system to enable group data visualization in the group collaboration process.

FIG. 6 illustrates a functional block diagram for operation of the collaborative network system to push information to participants' displays and to the event/meeting display for successive steps of an activity in the group collaboration process.

FIG. 7 illustrates a functional block diagram for operation of the three sets (control, users, event/meeting) screens for successive steps of an activity in the group collaboration process.

FIG. 8 illustrates a functional block diagram for operation of the control screen for successive steps of an activity in the group collaboration process.

FIG. 9 illustrates a functional block diagram for operation of the users screens for successive steps of an activity in the group collaboration process.

FIG. 10 illustrates a functional block diagram for operation of the event/meeting screen for successive steps of an activity in the group collaboration process.

### DETAILED DESCRIPTION OF PREFERRED EMBODIMENTS

In the following detailed description, certain preferred embodiments are described as illustrations of the invention in a specific application, network, or computer environment in order to provide a thorough understanding of the present invention. Those methods, procedures, components, or functions that are commonly known to persons of ordinary skill in the field of the invention are not described in detail as not to unnecessarily obscure a concise description of the present invention. Certain specific embodiments or examples are given for purposes of illustration only, and it will be recognized by one skilled in the art that the present invention may be practiced in other analogous applications or environments and/or with other analogous or equivalent variations of the illustrative embodiments.

Some portions of the detailed description that follows are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities.

Unless specifically stated otherwise as apparent from the following discussions, it is appreciated that throughout the present invention, discussions utilizing terms such as “processing” or “computing” or “translating” or “calculating” or “determining” or “displaying” or “recognizing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

A computer or computing resource commonly includes one or more input devices electronically coupled to a processor for executing one or more computer programs for producing an intended computing output. The computer is typically connected as a computing resource and/or communications device on a network with other computer systems. The networked computer systems may be of different types, such as remote PCs, master servers, network servers, and personal mobile devices connected via a wired, wireless, or mobile communications network.

The term “Internet” refers to a structure of global networks connecting a universe of users via a common or industry-standard (TCP/IP) protocol. Users having a connection to the Internet commonly use browsers on their computers or client devices to connect to websites maintained on web servers that provide informational content or business processes to users. The Internet can also be connected to mobile networks using data handling protocols to connect Internet websites to wireless data networks. Wireless data networks are deployed worldwide and allow users anywhere to connect to the Internet via wireless data or smartphone devices.

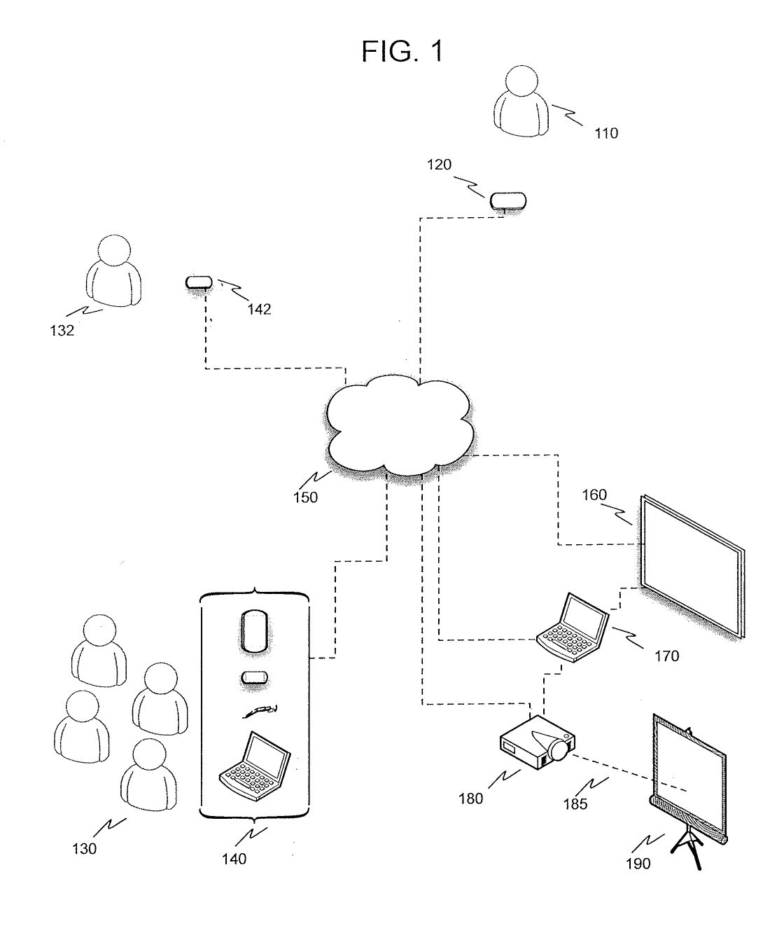

FIG. 1 shows an exemplary overview of a system for operating a collaborative network in accordance with the present invention. A group leader 110 at a group meeting location may have a personal networked device 120 that may be used as a control device for communications with a web-based control server 150 for the collaborative network system. The group leader 110 may interface with the control server 150 using the control device 120 to create group process parameters for the collaborative network system. In a preferred embodiment, a control display panel 160 may be directly connected via Internet to the control server 150 or via a networked device 170 to receive and display data for control of the group process. For participants gathered at the group meeting location, an event/meeting display may be configured with a projection device 180 capable of receiving data from the control server 150 directly or via the networked device 170 for projecting an image 185 onto an event/meeting display screen 190. The control system can send results data on the current activity step to the event/meeting display screen 190 and participant data on the next activity step to the participant devices 140 using a single button on the control device 120. The system can send different data to a non-attending participant 132 via networked computer device 142 and any number of groups of attending participants 130 via networked devices 140.

The personal networked devices 140 may include, but are not limited to, a shared laptop, a personal laptop, a smartphone, tablet, wearable computer, or PDA. The control device 120 and the participant personal networked devices 140 communicate with the control system server 150. The control device 120 operated by the group leader (administrator) can send data through the control server 150 to each of the participant's personal networked devices 140. This data might include instructions, activities, questions, games, and other interactive interfaces. Additionally, non-attending participants 132 and their personal networked devices 142 can also communicate with the control server 150 to receive data from the control device 120.

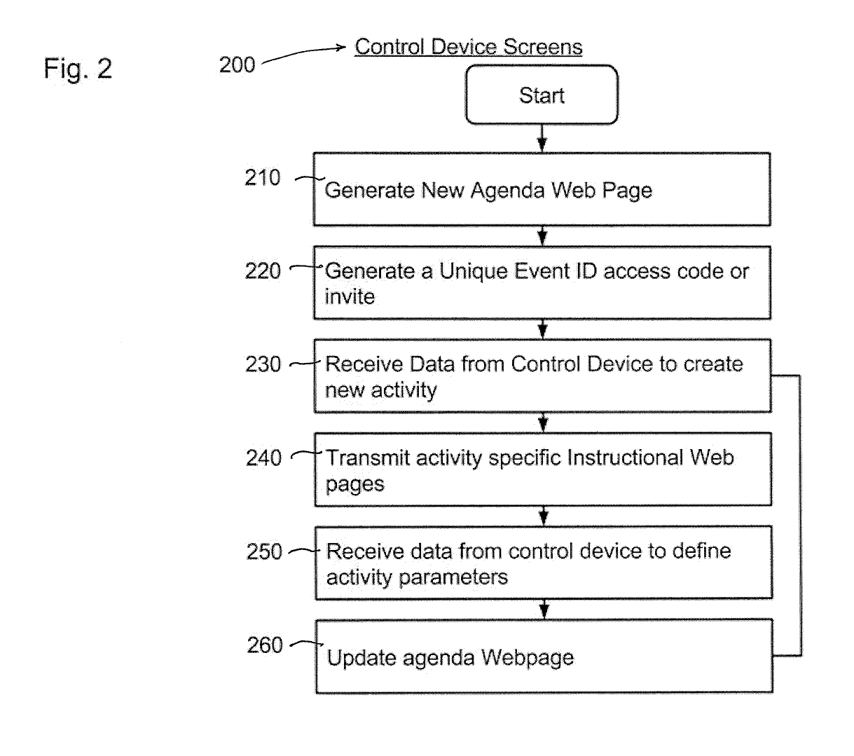

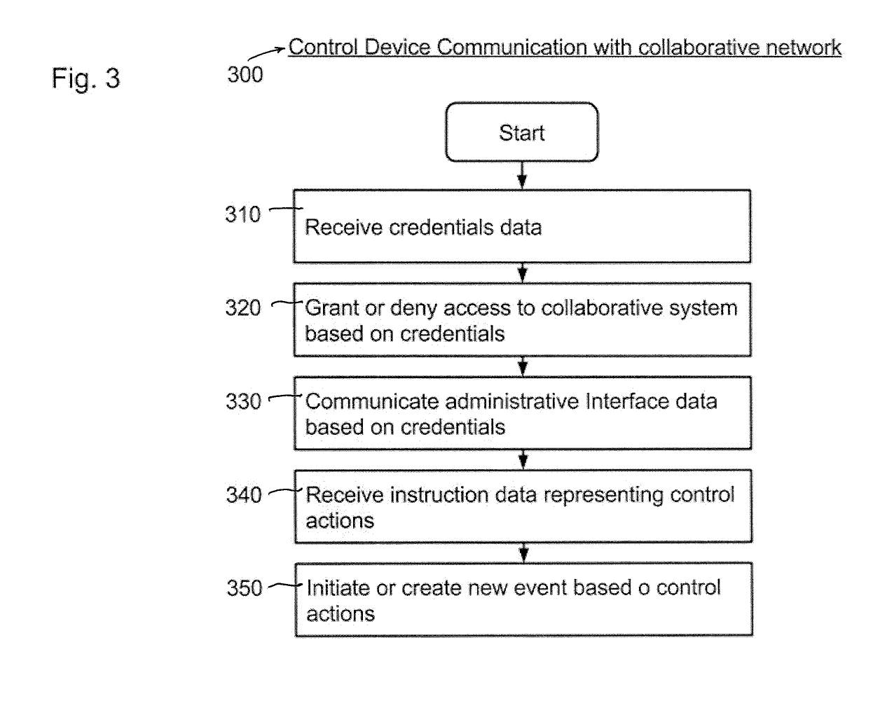

FIG. 2 shows a functional block diagram 200 for communication between the control device 120 and the control server 150 for the collaborative system network. In this example, the control server 150 creates new agenda page at block 210 upon receiving instructions from the control device via a process that is described in more detail in conjunction with FIG. 3. The control server 150 also creates a unique event identifier at block 220 to accompany the new agenda page. The control server 150 then receives instructions for creating a new activity at block 230 from the control device 120 and transmits activity specific webpages at block 240 back to the control device 120. The control device 120 will continue to refine the activity parameter at block 250 by sending data to the collaborative system network 150 which will in turn update the agenda page at block 260.

With reference to FIG. 3, a functional block diagram 300 for allowing a control device 120 to communicate with a collaborative system network is shown. The method begins with the control server 150 for the collaborative system network receiving credentials data at block 310 from the control device 120. The credentials are then checked against a database to confirm their validity and grant or deny access at block 320 to the control server 150 to the control device 120. Upon granting access to the control device 120, the control server 150 will transmit administrator interface data to the device at block 330. The instructional data received at block 340 by the control server 150 will enable ongoing communication with the control device 120 for the group process like building an agenda as referenced in FIG. 2 and sending interface data.

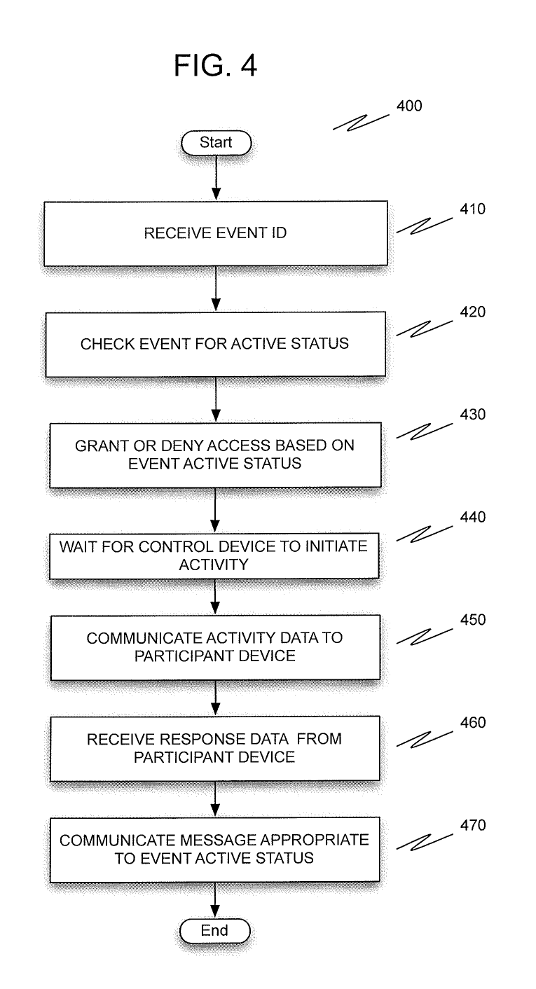

FIG. 4 shows a functional block diagram 400 for allowing a participants personal networked device 130 to access and exchange data with the collaborative system network 150. The control system can grant access based on either having a predefined set of participants invited to the collaborative system or based on an event/meeting code. First, the system receives invite credentials or event code from the participant device at block 410 and checks that event that code is associated with at block 420. The control server 150 will then grant or deny access to the participants personal networked device 130 based on the activity status of the event at block 430. The system will send needed credentials such as meeting id, encryption string, decryption string, channel(s), assigned user id, and then assign the system to a communication channel in which the device 140 awaits further instruction from the control server 150. The control server 150 then waits for data from the control device 120 before communicating data to the participant devices at block 450. As participant personal networked devices 130 receive input from the participants, the data is received at block 460 by the control server 150. The control server 150 then communicates appropriate data at block 470 back to the participant personal networked device 130.

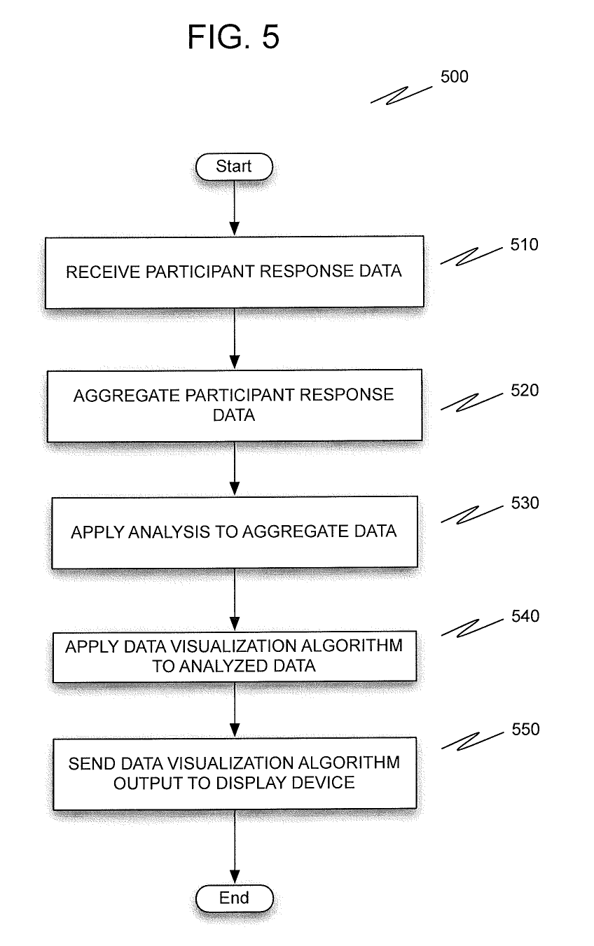

FIG. 5 shows a functional block diagram 500 for the control server 150 to receive and process participant data. The system receives data from the participant devices at block 510. When the system receives the data, it checks to see if the activity/step settings state it should be anonymous or not and then stores the right credentials. The system can store both anonymous data and non-anonymous data, but still correlate responses across activities. The system stores responses in a database at block 520. The aggregated data is analyzed at block 530 and the aggregated results are sent to and then passed on to a visualization algorithm at block 540. The output from the data visualization algorithm is then transmitted to the event/meeting output displays 160, the onsite control system computer device 170, the event/meeting display projector 180, and/or to the participants' devices 140.

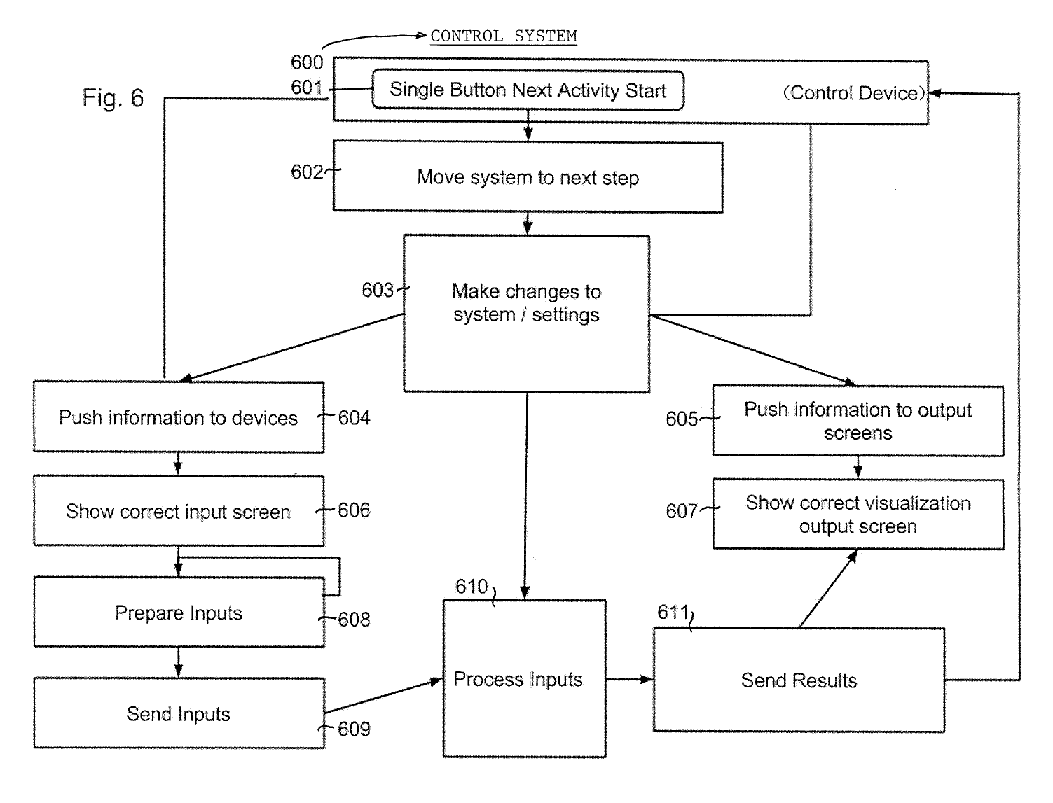

FIG. 6 shows a functional block diagram 600 for the control system 600 to start a new activity step in a group process. By clicking a single “Next” button of the control device at block 601, the system closes any previous step (if open), and moves the system to the next step in the activity list at block 602. The system initiates any required setting changes to the system at block 603. Any needed setting changes are sent to the participants devices at block 604. New settings are simultaneous sent to the output screens at block 605 of the control system and the event/meeting display. When individual settings are sent to all user devices at block 606, the user displays show the respectively correct input screens for the next activity step. The input screen can have multiple input screens per step as decided by the individual activity and respective setting. The user inputs are prepared at block 608. The inputs can then be sent in response to the current activity step at block 609. Once the inputs are received, they are processed by the control server at block 610 and stored in the database, and then sent to the output screens at block 607. The control device 601 is also used to change settings during the next step to provide new parameters for the new output. For instance if the host 110 using the control device 601 decides to show a correlation between a current activity step and a previous activity step, that setting can be sent to the control server at block 603, and that in turn changes how to process the participant inputs at block 610. The control device can also push information to individual participant devices, and to communicate directly with one of more devices separately.

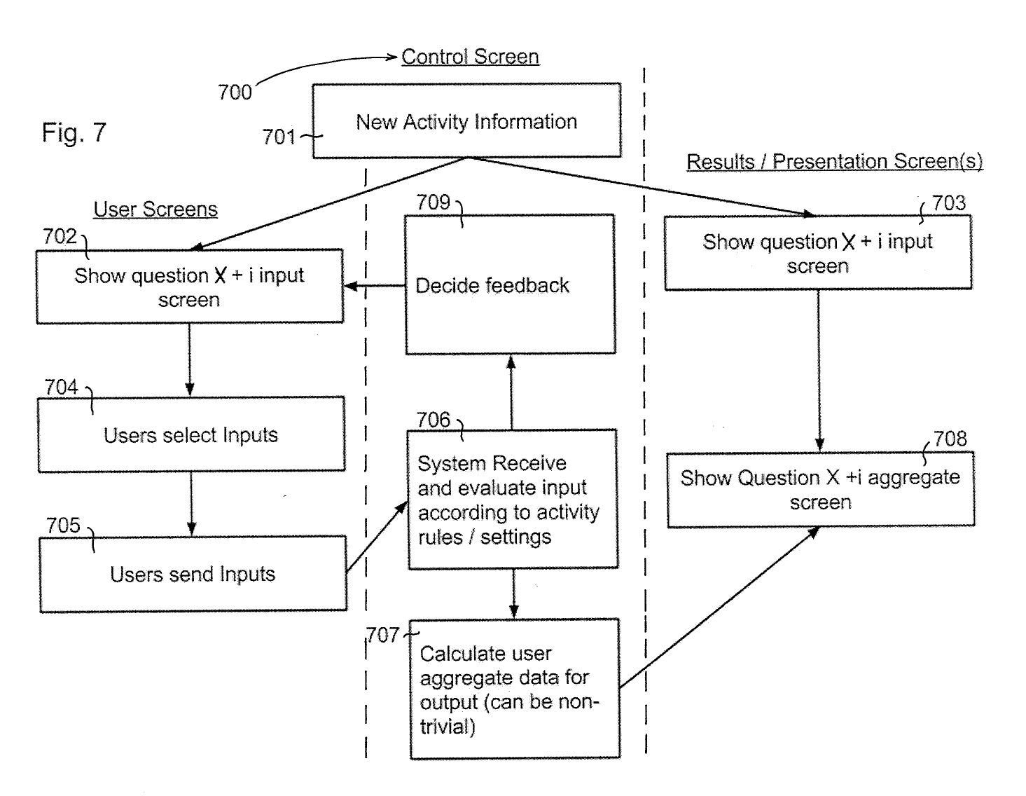

FIG. 7 illustrates a functional block diagram for operation of the three sets (control, users, event/meeting) screens for successive steps of an activity in the group collaboration process. When a new activity step as displayed on the control screen 700 is initiated at block 701, the new activity step information such as a question X+i is pushed for display on both the participant screens at block 702 and the event/meeting output screens at block 703. When the participants have selected their inputs at block 704 and sent them to the control server at block 705, the system receives it at block 706 where it evaluates the inputs and performs any needed cleanup before storing in the database. The system performs the step calculations at block 707, such as calculating an aggregate score or rating or counting yes/no votes, then sends the aggregate results to the event/meeting output screens at block 708. The system can also decide on any feedback to participants at block 709 and sends it to the user screens for display, prior to or along with sending new information for the next activity step at block 702. This can contain information for the participant to continue evaluating different aspects of the same activity, or it could contain information about the results from the participant contribution. For instance if the participant has given judgment on a specific term, the system could present the user individually with a new term to judge.

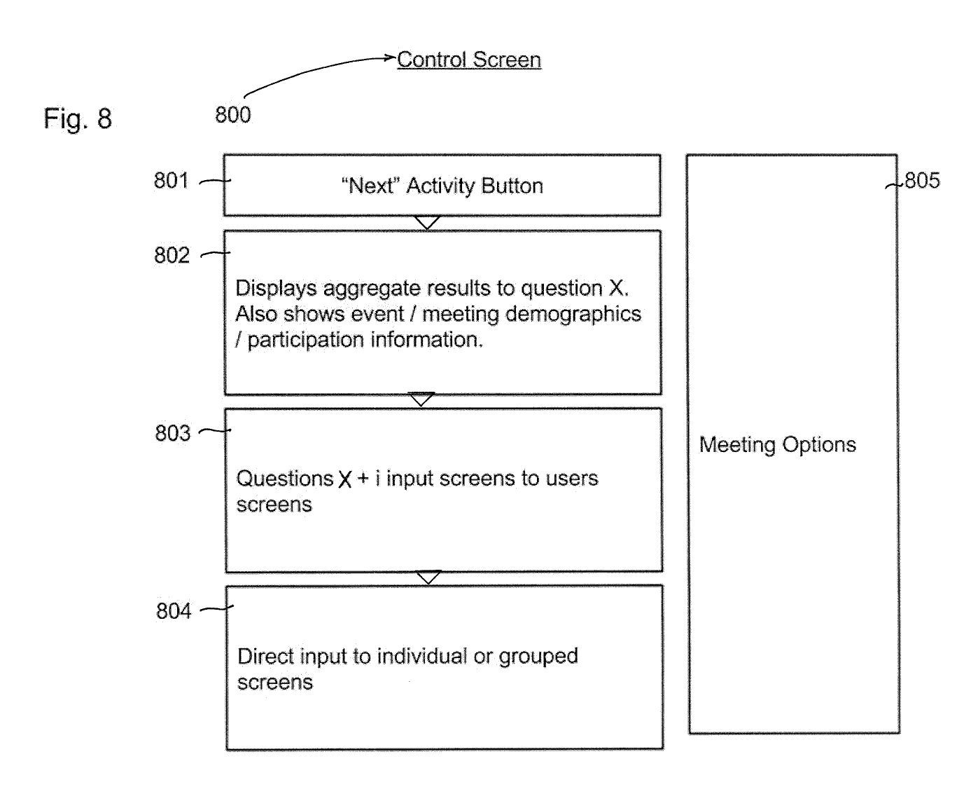

FIG. 8 illustrates a functional block diagram for operation of the control screen 800 for successive steps of an activity in the group collaboration process. Upon actuating a “Next” command to the control system at block 801, such as by clicking on a “Next” icon or button in the control screen display using a control device such as a remote control unit or cursor, the control system sends information to display the calculated aggregated results to the current activity step, such as a question X, on the event/meeting display screen at block 802 in order to provide real-time feedback to the participant group of the consensus, voting, or responses of the group on question X. At the same time, the control system sends information to display the next activity step such as a question X+i, on the display screens of the participant users' mobile devices at block 803. Other information input may also be directed to the individual users' or event/meeting display screens at block 804, as well as other meeting options at block 805.

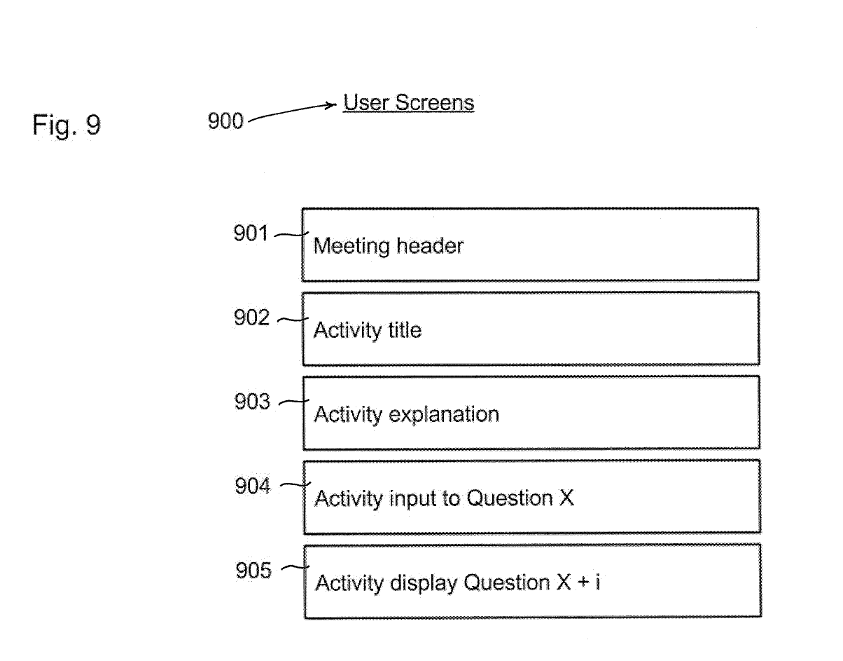

FIG. 9 illustrates a functional block diagram for operation of the users screens for successive steps of an activity in the group collaboration process. The control system controls the sending of information for display on the screens 900 of the participant users' mobile devices, such as a meeting header at block 901, the activity title at block 902, the activity explanation at block 903, a prompt for user input on question X at block 904, followed by a prompt for user input on the next question X+i at block 905, etc.

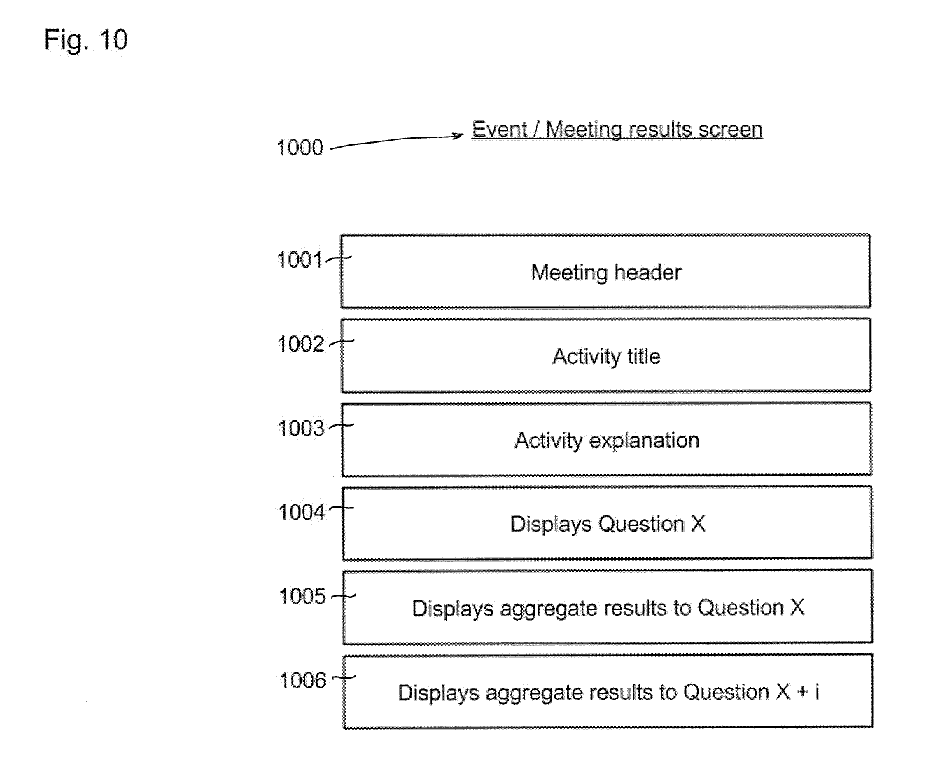

FIG. 10 illustrates a functional block diagram for operation of the event/meeting screen for successive steps of an activity in the group collaboration process. The control system controls the sending of information for display on the screen 1000 for the event/meeting presentation to those participants attending, such as a meeting header at block 1001, the activity title at block 1002, the activity explanation at block 1003, a display of question X at block 1004, followed by a display of the aggregated results to question X at block 1005, then a display of the next question X+i at block 1006, etc. The event/meeting display may retain the aggregated results to prior questions on the event/meeting screen or retain only the aggregated results that are relevant to the next question X+i, depending on the subject matter content of the group activity steps.

In a preferred implementation, the participant users can access the website for the event/meeting activity using mobile networked devices such as smartphones. The control system can push display information to a user's device that readily fits on a “small” smartphone display screen, such as a display of only one question at a time in the group activity, and the user can respond with input of only one question at a time that is readily handled by the softkey input of the typical smartphone device. Meanwhile, aggregated information for the event/meeting presentation to the group as a whole is pushed by the control system to a “big” event/meeting display screen. This use of the “big” event/meeting screen for group presentation enables real-time interactivity for the participant group combined with mobility and ease-of-use for ongoing participant input to the group activity via the “small” screens of their personal mobile devices.

The advantages of the present invention include, without limitation, that it provides a collaborative system that is universally accessible across all personal networked devices. This system is easy to deploy because of its platform independence, and requires no additional purchases of system specific hardware. This collaborative system network is easily scalable to accommodate any size group of participants. The use of a control device to orchestrate a unified experience across all participant devices allows this system to unify participation in complex, multi-step group processes. The separate display for data visualization creates a focal point for participant attention, and also requires no system specific hardware

In broad embodiment, the present invention is network of devices in which a single device can direct the interface of all others, and in which visualization data is sent to a separate display. In addition, both the participants display interface and the event/meeting display may be controlled using one and the same button on the control device. By pressing the control button on the control device participants screen will have one interface and the display screen another. Participants screens may have one or multiple different screens and content controlled by the control device from the click of one button. The control device may control the event/meeting screen separately or in unison with participant screens. The control device can control individual participant screens as one group, as multiple groups with one or more participants. The control device can also control individual screens separately from the rest of the group. All data input may be tracked across meeting participants, so that real-time visualizations of correlated results can be shown to the meeting participants. The meeting facilitator may toggle on and off participant anonymity yet still keep the overall comparative data. The system can perform correlations on data collected between steps, yet keep data anonymous. Participant screens will show the participants if their contribution is anonymous or not, and whether participants have to log-on using identifiable information.

The above-described system and method of operating a collaborative network provides a new capability to control how real-time participant-aggregate information is pushed to the conference presentation screen in tandem with pushing activity process information is pushed to the participant users screens to accomplish a real-time participant-conference interactivity. In a basic mode of operation, participant users are prompted to input responses to a first activity question or prompt, then the control system aggregates the responses and upon the operator pushing the “Next” button on the control screen, the tabulated results to the first activity question or prompt are pushed to the conference presentation screen while the next activity question or prompt is sent to the participant users screens. This “three-screen” mode of operation enables the conference presentation screen to give the participant users feedback on their collective inputs to the previous activity question or prompt while the users screens are updated to prompt them for their next input.

The “three-screen” mode of operation can change the way live meetings work in by enabling participants to provide real-time inputs to the meeting activity through their mobile personal devices such as smartphones. A user can pose questions, rate answers, answer questions, and get a report on what was exchanged with each step of the group activity. This real-time interactivity can make meetings more energetic and productive. User inputs are anonymous and aggregated to feedback the consensus of the group. Users know their answers are being included, and that encourages them to participate. The control system can be programmed to interpret the aggregated data before displaying it, thereby making the interaction more meaningful and the visualization displays more comprehensible. If the meeting is webcast or broadcast by audio or video, the collaborative network can be extended to users not attending at the physical event/meeting location.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, method, and examples, but encompasses all embodiments and methods within the scope and spirit of the invention described.

We claim:

1. A method of operating a collaborative network of participants attending an event/meeting presentation in person using networked computer devices connected via Internet, comprising:
operating a web-based control server connected online with a plurality of participant users attending the event/meeting presentation in person using personal networked computer devices to receive inputs from and to send information for display to the participant users on display screens of their personal networked computer devices, and to send information for display on an event/meeting display screen for the event/meeting presentation to the plurality of participant users attending the event/meeting in person,
wherein operating the web-based control server includes:
(1) sending a question or prompt to the participant users on display screens of their personal networked computer devices for participant users' inputs to a current activity step of the group activity;
(2) receiving participant users' inputs via their personal networked computer devices to a current activity step of the group activity;
(3) calculating aggregated results of participant users' inputs to the current activity step of the group activity;
(4) sending the aggregated results of participant users' inputs to the current activity step of the group activity for display on the event/meeting display screen to the plurality of participant users; and
(5) sending a question or prompt to the participant users on display screens of their personal networked computer devices for participant users' inputs to a next activity step of the group activity,
whereby real-time group interactivity of participants in the event/meeting presentation for the group activity is enabled through mobility and convenience of participant users using their networked personal computer devices.

2. A method of operating a collaborative network according to claim 1, wherein operating the web-based control server includes displaying control information to a group activity leader for the activity steps of the group activity on a control display screen in a three-screen configuration of information with the participant users' display screens and the event/meeting display screen, and receiving group activity leader commands to the control server via a remote control or cursor device.

3. A method of operating a collaborative network according to claim 2, wherein receiving a group activity leader command for performing method steps (4) and (5) is obtained by the group activity leader clicking a single Next button or icon using the remote control or cursor device.

4. A method of operating a collaborative network according to claim 1, wherein operating the web-based control server includes formatting information for one question or prompt at a time to fit on comparatively smaller user display screens of their personal networked computer devices, and formatting information for aggregated results in the event/meeting presentation to be displayed on the comparatively larger event/meeting display screen.

5. A method of operating a collaborative network according to claim 4, wherein formatting information for one question or prompt at a time is designed to fit on display screens of smartphones as the personal networked computer devices.

6. A method of operating a collaborative network according to claim 1, wherein operating the web-based control server includes receiving inputs from and sending information for display to users not attending the event/meeting in person via their personal networked computer devices connected online with the control server.

7. A method of operating a collaborative network according to claim 1, wherein operating the web-based control server includes connecting it to a networked computer device for the event/meeting presentation at a physical location, such as at a meeting location, conference room, and videoconference center.

8. A method of operating a collaborative network according to claim 1, wherein operating the web-based control server includes controlling participation of users in the event/meeting by allowing and/or restrict participant access to steps or to the group activity by controlling the interface of each participant's networked personal computer device.

9. A method of operating a collaborative network according to claim 1, wherein operating the web-based control server includes storing participant data gathered from participants and using the participant data for analysis for generating a group data visualization display on the event/meeting display screen.

10. A method of operating a collaborative network according to claim 1, wherein operating the web-based control server includes controlling selected individual participant display screens as a group or as multiple groups of respectively selected or self-selected participants.

11. A system for operating a collaborative network of participants attending an event/meeting presentation in person using networked computer devices connected via Internet, comprising:
a web-based control server connected online with a plurality of participant users attending the event/meeting presentation in person using personal networked computer devices, wherein the web-based control server is operated to receive inputs from and to send information for display to the participant users on display screens of their personal networked computer devices, and to send information for display on an event/meeting display screen for the event/meeting presentation to the plurality of participant users attending the event/meeting in person,
wherein the web-based control server includes functional programmed control for:
(1) sending a question or prompt to the participant users on display screens of their personal networked computer devices for participant users' inputs to a current activity step of the group activity;
(2) receiving participant users' inputs via their personal networked computer devices to a current activity step of the group activity;
(3) calculating aggregated results of participant users' inputs to the current activity step of the group activity;
(4) sending the aggregated results of participant users' inputs to the current activity step of the group activity for display on the event/meeting display screen to the plurality of participant users; and
(5) sending a question or prompt to the participant users on display screens of their personal networked computer devices for participant users' inputs to a next activity step of the group activity,
whereby real-time group interactivity of participants in the event/meeting presentation for the group activity is enabled through mobility and convenience of participant users using their networked personal computer devices.

12. A system for operating a collaborative network according to claim 11, wherein the web-based control server includes functional programmed control for displaying control information to a group activity leader for the activity steps of the group activity on a control display screen in a three-screen configuration of information with the participant users' display screens and the event/meeting display screen, and for receiving group activity leader commands to the control server via a remote control or cursor device.

13. A system for operating a collaborative network according to claim 12, wherein the functional programmed control for receiving a group activity leader command for performing program steps (4) and (5) is obtained by the group activity leader clicking a single Next button or icon using the remote control or cursor device.

14. A system for operating a collaborative network according to claim 11, wherein the web-based control server includes functional programmed control for formatting information for one question or prompt at a time to fit on comparatively smaller user display screens of their personal networked computer devices, and for formatting information for aggregated results in the event/meeting presentation to be displayed on the comparatively larger event/meeting display screen.

15. A system for operating a collaborative network according to claim 14, wherein the functional programmed control for formatting information for one question or prompt at a time is designed to fit on display screens of smartphones as the personal networked computer devices.

16. A system for operating a collaborative network according to claim 11, wherein the web-based control server includes functional programmed control for receiving inputs from and sending information for display to users not attending the event/meeting in person via their personal networked computer devices connected online with the control server.

17. A system for operating a collaborative network according to claim 11, wherein the web-based control server includes functional programmed control for connecting it to a networked computer device for the event/meeting presentation at a physical location, such as at a meeting location, conference room, and videoconference center.

18. A system for operating a collaborative network according to claim 11, wherein the web-based control server includes functional programmed control for controlling participation of users in the event/meeting by allowing and/or restrict participant access to steps or to the group activity by controlling the interface of each participant's networked personal computer device.

19. A system for operating a collaborative network according to claim 11, wherein the web-based control server includes functional programmed control for storing participant data gathered from participants and using the participant data for analysis for generating a group data visualization display on the event/meeting display screen.

20. A system for operating a collaborative network according to claim 11, wherein the web-based control server includes functional programmed control for controlling selected individual participant display screens as a group or as multiple groups of respectively selected or self-selected participants.
